(19) United States
(12) Patent Application Publication
(10) Pub. No.: US 2008/0243782 A1
(43) Pub. Date: Oct. 2, 2008

(54) Client collection membership evaluation

(75) Inventors: Dattatraya Rajpure, Redmond, WA (US); Eric Holtz, Kirkland, WA (US); David James, Bothell, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,018

(22) Filed: Mar. 28, 2007

(51) Int. Cl. G06F 17/30

(52) U.S. Cl. 707/3; 707/E17.014

(57) ABSTRACT

Client collection membership evaluation techniques are described. In an implementation, attributed are identified that define membership in one or more collections. A plurality of clients is monitored for changes to computing resources that correspond to the identified attributes. Membership of clients having the changes is evaluated using one or more queries that include one or more of the identified attributes from respective collections.

### BACKGROUND

Clients are continually deployed in every increasing numbers in a variety of environments. One such environment is commonly referred to as an enterprise system, which may include tens of thousands of clients. However, these clients may be configured in a variety of different ways to provide a wide variety of functionality, and therefore management of the clients may be complex.

Although techniques have been developed to enable an administrator to manage clients, traditional management techniques may still be insufficient when confronted with this ever increasing number of clients. For example, the administrator may group the clients into collections having similar functionality. Traditional techniques that were used to maintain these collections, however, filtered and grouped the clients based on queries which were applied to each of the clients. Further, as the number of clients increased, so to did the number of collections that were used to manage the clients. Therefore, assigning this ever increasing number of clients into a corresponding ever increasing number of collections may consume a significant amount of resources, such as processing and network resources as well as time on the part of the administrator to manage these collections.

### SUMMARY

Client collection membership evaluation techniques are described. In an implementation, attributes are identified that define membership in one or more collections. A plurality of clients is monitored for changes to computing resources that correspond to the identified attributes. Membership of clients having the changes is evaluated using one or more queries that include one or more of the identified attributes from respective collections.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ client collection membership evaluation techniques.

FIG. 2 is a flow diagram depicting a procedure in an exemplary implementation in which attributes that define membership in one or more collections are identified.

FIG. 3 is a flow diagram depicting a procedure in an exemplary implementation in which clients are monitored and evaluated based on changes to attributes that were identified according to the procedure 200 of FIG. 2.

FIG. 4 is a flow diagram depicting a procedure in an exemplary implementation in which resource tables and structured query language (SQL) queries are used to provide real-time evaluation of collection membership.

### DETAILED DESCRIPTION

Overview

Forming collections of clients is the backbone of management techniques for large deployments of clients, such as deployments of clients in an enterprise system that may include tens of thousands and even hundreds of thousands of clients. For example, by forming collections of clients that have similar functionality, techniques may be employed to manage each of the clients in the collection, such as to deploy software, implement a policy, and so on. Traditional techniques that were employed to manage these collections, however, were resource intensive and therefore acted as a bottleneck in the ability of an administrator to manage the clients. Traditional techniques, for instance, may consume a large amount of resources and take a significant amount of time to complete, and therefore were oftentimes untimely as the enterprise system continued to change.

Techniques are described to evaluate membership of clients in collections. In at least one implementation, collections are evaluated to determine which attributes are used to determine membership in collections used to manage the clients, such as particular hardware (e.g., a particular amount of memory, a particular processor), software (e.g., running a particular version of an operating system), and/or network resources (e.g., amount of bandwidth, type of network connection). The collections may be formed for a variety of purposes, such as to implement policies to deploy software (e.g., a software update), and so on. Attributes that are used to determine membership are then monitored to detect when changes are made. Thus, in this way attributes that are not used to define membership may not be monitored, thereby reducing overhead of the monitoring process.

Further, when changes are made to particular attributes, collections which use the changed attribute to determine membership may be used to evaluate membership of the client in the collections, as opposed to collections which do not rely on the attribute. Thus, this may be used to further improve efficiency of the client collection process. Further discussion of these techniques may be found in relation to the following discussion.

An exemplary environment is first described which is operable to employ client collection membership evaluation techniques. Exemplary procedures are then described, which may be employed in the exemplary environment as well as in other environments.

Exemplary Environment

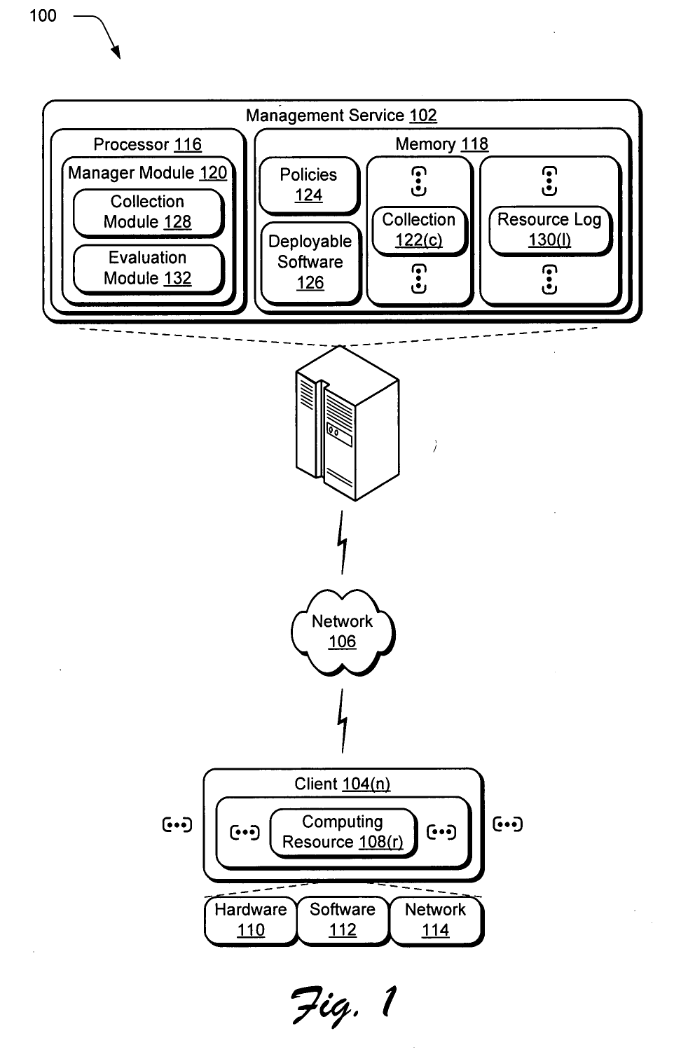

FIG. 1 is an illustration of an environment 100 in an exemplary implementation that is operable to employ client collection membership evaluation techniques. The illustrated environment 100 includes a management service 102 and a plurality of clients 104(n) (where “n” can be any integer from one to “N”) that are communicatively coupled, one to another, over a network 106. In the following discussion, the client 104(n) may be representative of a plurality of clients as a whole and/or a particular client, and therefore reference may be made in singular form (e.g., the client 104(n)) or plural form (e.g., the plurality of clients 104(n)).

The clients 104(n) may be configured in a variety of ways. For example, the client 104 may be configured as a computer that is capable of communicating over the network 106, such as a desktop computer, a mobile station, an entertainment appliance, a set-top box communicatively coupled to a display device, a wireless phone, a game console, and so forth. The clients 104(n) may also relate to an entity that operates the clients. In other words, clients 104(n) may describe logical clients that include software.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks, such as an Ethernet and the Internet. A wide variety of other instances are also contemplated.

Each of the clients 104(n) may incorporate a wide variety of computing resources 108(r), where “r” can be any integer from one to “R”. For example, the computing resources 108(r) may include hardware 110, such as processors, memory, display devices, network cards, peripheral devices, and so on. The computing resources 108(r) may also include software 112, such as data, applications and other modules which are executable to provide functionality including device drivers, operating systems, and so on. Further, the computing resources 108(r) may also include network 114 resources, such as an amount of bandwidth available to the client 104(n), type of network connection (e.g., wireless, Ethernet), and so on. Further, the computing resources 108(r) for one of the clients 104(n) may be different than the computing resources 108(r) for another one of the clients 104(n).

The management service 102 is illustrated in the environment 100 of FIG. 1 as being implemented by a server having a processor 116 and memory 118, although the server may be representative of one or more servers, such as a server farm. The management service 102 is also illustrated as including a manager module 120 as being executed on the processor 116 and is storable in memory 118 or other computer-readable media. The manager module 120 is representative of functionality to manage the clients 104(n), such as in an enterprise system.

The management service 102, for instance, may execute the manager module 120 to form one or more collections 122(c), where “c” can be any integer from one to “C” and therefore the collections 122(c) may be referenced in single or plural form in the following discussion. The collections 122(c) may be defined to include clients 104(n) having the same or similar computing resources 108(r) through use of a query. The query may be defined in a variety of ways, such as to reference attributes of the computing resources 108(r) of the clients 104(n) in a statement, e.g., by using a structured query language (SQL). By using SQL to form the query, “rich” definitions of attributes may be used to define “what it takes” to be a member of the collection 122(c). A variety of other techniques may also be employed to define the queries without departing from the spirit and scope thereof, e.g., a simple Boolean statement referencing attributes of the computing resources 108(r).

The collections 122(c) may be defined for a variety of purposes, such as to implement one or more policies 124, distribute deployable software 126, and so on. For example, each of the policies 124 may be targeted toward particular computing resources 108(r) of the clients, such as to turn on and off functionality, permit different levels of network access, and so on. In another example, the deployable software 126 may also be targeted towards particular clients 104(n), such as to update particular software that is out-of-date. Therefore, the collections 122(c) (and more particularly queries in the respective collections 122(c)) may be used to define the “type” of client 104(n) that is to be targeted.

As previously described, however, the number of clients 104(n) that may be deployed is ever increasing, and so to are the variety of computing resources 108(r) that are available via the clients 104(n). Consequently, the number of collections 122(c) that are used by the management service 102 to mange the clients 104(n) is also ever increasing, as it may not be unusual to include thousands of collections 122(c) to address tens of thousands and even hundreds of thousands of clients 104(n).

Traditional techniques that were used to evaluate client collection membership, however, typically applied the query used to define the collection 122(c) to each of the clients 104(n). Therefore, the number of collections 122(c) typically increased as did the amount of resources consumed to evaluate membership of the clients 104(n) in the collections, regardless of whether the collection included an attribute that was changed by one or more of the clients 104(n). Additionally, the amount of resources consumed to evaluate membership also increased as the number of clients 104(n) increased, regardless of how many changes to attributes were made and/or which clients 104(n) experienced a change in attributes.

Accordingly, techniques are described to evaluated client collection membership. For example, the manager module 120 may include a collection module 128 which is representative of functionality to identify which attributes are used by queries in the collections 122(c) to determine membership in the respective collections 122(c).

The collection module 128 may also be representative of functionality to monitor those attributes, e.g., changes to the corresponding computing resources 108(r) of the clients 104(n). For example, the collection module 128 may determine that one attribute of a collection 122(c) involves a particular amount of memory (e.g., total physical memory equal to 522,200) and may therefore monitor that attribute. For instance, the collection module 128 may maintain one or more resource logs 130(l) (where “L” can be any integer from one to “L”) that describes the computing resources 108(r) of the clients 104(n) and set “flags” to indicate changes to respective resources. In this way, the collection module 128 may be used to monitor those attributes which are identified as relevant to the collections 122(c) and may ignore attributes that are not relevant. Further discussion of identification and monitoring may be found in relation to the exemplary procedures.

The manager module 120 is also illustrated as including an evaluation module 132 which is representative of functionality to evaluate membership of the clients 104(n) in the respective collections 122(c). The evaluation module 132, for instance, may be executed to examine the resource log 130(l) and identify resources that have been flagged as being changed by the collection module 128. The evaluation module 132 may then evaluate membership of client 104(n) having the changed resources (i.e., the attribute for the computer resource 108(r) has changed) such that clients 104(n) that have not experienced the change (e.g., are not relevant) are not evaluated, thereby improving efficiency of the evaluation process. Further, the efficiency may be further improved by evaluation membership to collections 122(c) that include the changed attribute. Therefore, collections 122(c) that do not involve the changed attribute and therefore will not experience a change in membership may be ignored.

In this way, the client collection membership evaluation techniques may be employed in real time and therefore membership of the clients 104(n) in the collections 122(c) may be kept up-to-date. For example, the identification of attributes, monitoring of attributes and evaluation of membership may be employed in real time to address changes that continue to occur in the environment 100. In an implementation, a “complete” evaluation may also be scheduled such that clients 104(n) and/or collection 122(c) that have not been identified to include changes to attributes are also evaluated to account for “missed” changes. Thus, the “complete” evaluation may be performed less frequently than the real-time evaluation, thus preserving the integrity of the collections yet still addressing changes as they occur. Further discussion of real time monitoring and evaluation may be found in relation to the following procedures.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, e.g., the memory 118 of the server of FIG. 1. The features of the client collection membership evaluation techniques described below are platform-independent, meaning that the techniques may be implemented on a variety of commercial computing platforms having a variety of processors.

Exemplary Procedures

The following discussion describes client collection membership evaluation techniques that may be implemented utilizing the previously described systems and devices. Aspects of each of the procedures may be implemented in hardware, firmware, or software, or a combination thereof and may be stored in computer-readable media, e.g., the memory 118 of FIG. 1. The procedures are shown as a set of blocks that specify operations performed by one or more devices and are not necessarily limited to the orders shown for performing the operations by the respective blocks. In portions of the following discussion, reference will be made to the environment 100 of FIG. 1.

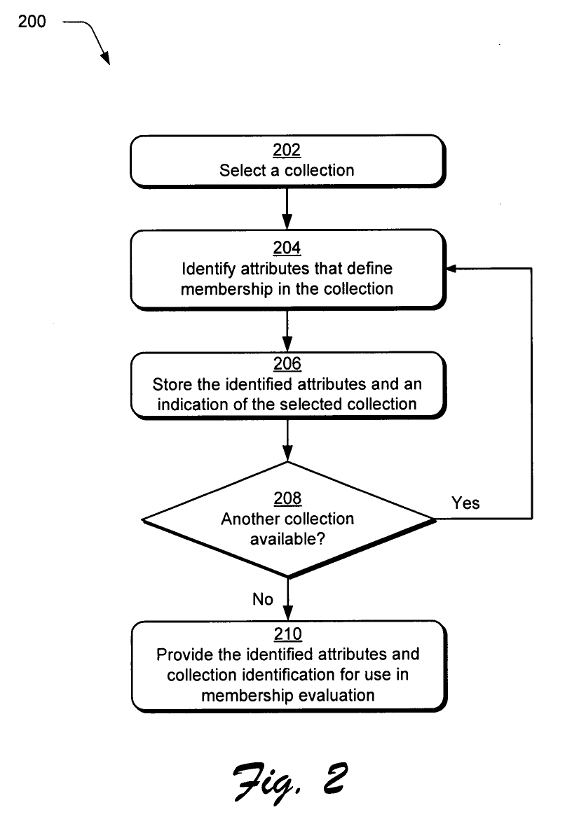

FIG. 2 depicts procedures 200 in an exemplary implementation in which attributes are identified that define membership in one or more collections. A collection is selected (block 202). The collection module 128, for instance, may select collection 122(c) from memory 118.

Attributes are identified that define membership in the collection (block 204). The collection module 128 may parse a query (e.g., which may be configured as a SQL statement, used direct member rules, and so on) to locate attributes that are used to define membership in the respective collection.

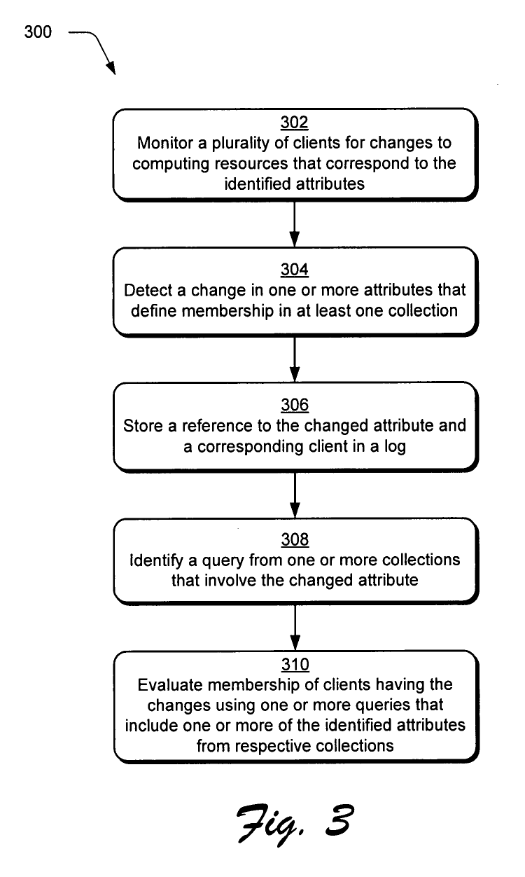

The identified attributes and an indication of the selected collection are then stored (block 206). Thus, the collection which corresponds to the identified attribute may be located by the evaluation module 132 to improve efficiency of the evaluation process, further discussion of which may be found in relation to FIG. 3.

A determination is then made as to whether another collection is available (decision block 208). If so (“yes” from decision block 208), attributes that define membership are collected (block 204) and stored (block 206) as previously described. Thus, the collection module 128 may continue to process the collections 122(c) available from memory 118. When another collection is not available (“no” from decision block 208), the identified attributes and collection identification are provided for use in membership evaluation (block 210), further discussion of which may be found in relation to the following figure.

FIG. 3 depicts a procedure 300 in an exemplary implementation in which clients are monitored and evaluated based on changes to attributes that were identified according to the procedure 200 of FIG. 2. A plurality of clients is monitored for changes to computing resources that correspond to the identified attributes (block 302). The monitoring may be performed in a variety of ways, such as by receiving data “pushed” from the clients 104(n), examination of the clients 104(n) and corresponding computing resources 108(r) by the collection module 128 over the network 106, and so on.

A change is detected in one or more attributes that define membership in at least one collection (block 304). Attributes for a particular client 104(n), for instance, may be compared with attributes that were previously stored in a resource log 130(l). In another instance, “new” entries in the resource log 130(l) may also be identified, such as for addition of a client 104(n) to the environment 100.

A reference to the changed attribute and a corresponding client are stored in a log (block 306). The evaluation module 132, for instance, may access the resource log 130(l) that describes each of the identified attributes. Attributes that have been changed may be indicated by a flag “next to” the respective attribute. Therefore, in this example the evaluation module 132 may “look” for flags indicating that a change has occurred and identify those changes.

Membership of clients having the changes is evaluated using one or more queries that include one or more of the identified attributes from respective collections (block 310). The evaluation module 132 may identify which attributes have been changed and then locate collections 122(c) having those identified attributes. The evaluation module 132 may also locate clients 104(n) that have experienced the identified changes. The located clients 104(n) may then be evaluated for membership in the collections 122(c) having the identified attributes. Thus, the attributes that are changed and the effect of those changes to particular collections 122(c) and client 104(n) may be used to improve efficiency of the evaluation process such that it may be performed “in real time”.

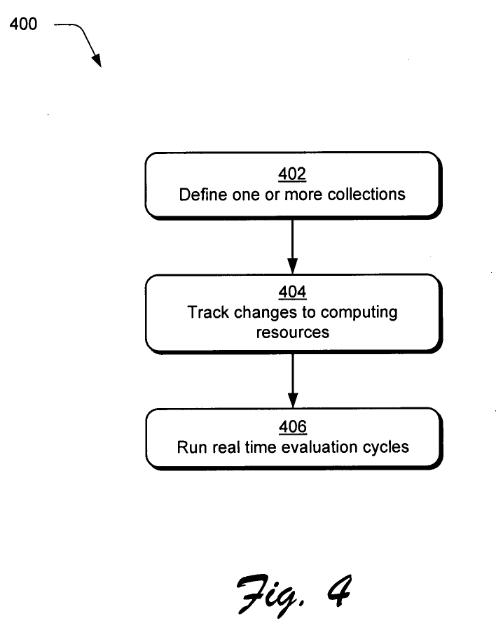

FIG. 4 depicts a procedure 400 in an exemplary implementation in which resource tables and structured query language (SQL) queries are used to provide real-time evaluation of collection membership. One or more collections are defined (block 402). As previously described, the collections 122(c) may be defined by the management service 102 in a variety of ways, such as defined via rules that can be query based, e.g., Windows Management Interface Query Language (WQL) (WINDOWS is a registered trademark of the Microsoft Corporation, Redmond, Wash.), direct member rules, and so on. For example, an administrator may define a collection 122(c) to include each client with a particular operating system. The WQL for such a collection may include an attribute that references a system resource tabled called “System_DISC” to filter each of the clients 104(n) with the particular operating system. When a new computing resource 108(r) (e.g., operating system) is added to the “System_DISC”, this collection is to be reevaluated to include the new computing resource 108(r).

Changes are tracked to the computing resources 108(r) (block 404) and real-time evaluation cycles are run (block 406), such as to update policy targeting, software deployment, and so on. For example, the collection module 128 may be executed to track the changes to the computing resources 108(r) and the evaluation module 132 may be executed to evaluate the effect of those changes on client 104(n) membership in collections 122(c).

For instance, each collection WQL query may reference resource discovery tables (e.g., “System_DISC”, “User_Disc”, “User_Group_DISC”, and so on) and other client 104(n) reported data tables, such as hardware 110 and software 122 inventory, status, and so on. Each client data table's primary key may reference back to associated resource discovery records as a foreign key. Additionally, a “dirty flag” may be added to the resource discovery tables which may be used to track the changed resource records from these tables. When a record in a discovery table is added or updated, the dirty flag may be triggered to “true”.

Therefore, when a collection 122(c) is created or updated the collection module 128 may parse the WQL associated with the collection 122(c) to find each of the client data tables that are referenced. The collection module 128 may then add a dynamic SQL trigger on each of these WQL referenced client data tables to mark dirty flags for the associated resource records in the resource discovery tables. The collection module 128 may also create a real-time evaluation SQL query for this collection to be used in real-time collection evaluation cycles, e.g., through execution of the evaluation module 132.

For example, when an administrator creates a new collection 122(c) for clients 104(n) having total physical memory of 522,200, an associated WQL query and real-time evaluation SQL query may be created as follows:

### Collection WQL Query:

select
SMS_R_System.ResourceID,SMS_R_System.ResourceType,
SMS_R_System.Name,SMS_R_System.SMSUniqueIdentifier,
SMS_R_System.ResourceDomainORWorkgroup,SMS_R_System.-
Client from
SMS_R_System inner join SMS_G_X86_PC_MEMORY on
SMS_G_System_X86_PC_MEMORY.Resourceid =
SMS_R_System.ResourceId where
SMS_G_System_X86_PC_MEMORY.TotalPhysicalMemory =
522200.

### Collection SQL Query:

select all
SMS_R_System.ItemKey,SMS_R_SYSTEM.DiscArchKey,
SMS_R_SYSTEM.Name0,SMS_R_SYSTEM.-
SMS_Unique_Identifier0,SMS_R_SYSTEM.-
Resource_Domain_OR_Workgr0,
SMS_R_System.Client0
from System_DISC AS SMS_R_SYSTEM
INNER JOIN PC_Memory_DATA AS
SMS_G_SYSTEM_X86_PC_MEMORY ON
SMS_G_SYSTEM_X86_PC_MEMORY.MachineID =
SMS_R_SYSTEM.ItemKey where
SMS_G_SYSTEM_X86_PC_MEMORY.TotalPhysicalMemory0 =
522200

### Collection Real-Time Evaluation SQL Query:

WITH
SMS_R_SYSTEM(ItemKey,DiscArchKey,Name0,
SMS_Unique_Identifier0,Resource_Domain_OR_Workgr0,
Client0) AS
(
select all
SMS_R_SYSTEM.ItemKey,SMS_R_SYSTEM.DiscArchKey,
SMS_R_SYSTEM.Name0,SMS_R_SYSTEM.-
SMS_Unique_Identifier0,
SMS_R_SYSTEM.Resource_Domain_OR_Workgr0,
SMS_R_SYSTEM.Client0
from System_DISC as SMS_R_SYSTEM
WHERE DirtyFlag IS NOT NULL
)
select all
SMS_R_SYSTEM.ItemKey,SMS_R_SYSTEM.DiscArchKey,
SMS_R_SYSTEM.Name0,SMS_R_SYSTEM.-
SMS_Unique_Identifier0,
SMS_R_SYSTEM.Resource_Domain_OR_Workgr0,
SMS_R_SYSTEM.Client0
from SMS_R_SYSTEM

| | |
|---|---|
| INNER JOIN PC_Memory_DATA | AS |
| SMS_G_SYSTEM_X86_PC_MEMORY | ON |
| SMS_G_SYSTEM_X86_PC_MEMORY.MachineID | = |
| SMS_R_SYSTEM.ItemKey | where |

SMS_G_SYSTEM_X86_PC_MEMORY.TotalPhysicalMemory0 =
522200

This WQL refers to the resource discovery table called “System_DISC” and client data table called “PC_Memory_Data” which is a hardware inventory table. The “PC_Memory_Data” table references back to the “System_DISC” table with a “MachineID” primary key. The collection module 128 may parse this WQL/SQL and dynamically add the SQL after a trigger on “PC_Memory_Data” table to mark a dirty flag for the corresponding client 104(n) record entry in the “System_DISC” table. The SQL after the trigger may mark the resource change when the property/column of “PC_Memory_Data” table referenced by WQL has been changed. This enables the evaluation module 132 to track changes at a property level and thus reduce undesired real-time evaluation cycles. Also real-time evaluation SQL query may be generated for this collection. When new hardware inventory is received at the clients 104(n), the physical memory records may be updated and thus corresponding resource records dirty bit is marked.

The evaluation module 132 may execute the real-time evaluation cycles regularly (e.g., every hour) which may be set by an administrator using site settings. In a real-time evaluation cycle, the evaluation module 132 may determine changes in resource discovery records and run the real-time collection evaluations SQL query which will include changed system records. When real-time collection evaluation cycle is complete, each of the dirty flags may be reset in the resource discovery tables.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A computer-implemented method comprising:
identifying attributes that define membership in one or more collections;
monitoring a plurality of clients for changes to computing resources that correspond to the identified attributes; and
evaluating membership of clients having the changes using one or more queries that include one or more of the identified attributes from respective said collections.

2. A computer-implemented method as described in claim 1, wherein the plurality of clients forms an enterprise system.

3. A computer-implemented method as described in claim 1, wherein one or more said collections are used to target one or more policies to manage the clients.

4. A computer-implemented method as described in claim 1, wherein the evaluating is performed such that at least one said client that is monitored that does not have a change to the identified one or more attributes is not evaluated.

5. A computer-implemented method as described in claim 1, wherein:
the evaluating is performed such that at least one said query from a corresponding said collection is not evaluated; and
the at least one said query does not have the identified attributes that are changed.

6. A computer-implemented method as described in claim 1, wherein the evaluating is performed using a log that references the changes to the identified attributes of respective said clients.

7. A computer-implemented method as described in claim 1, wherein the query is configured according to a structured query language (SQL).

8. A computer-implemented method as described in claim 1, further comprising identifying the collections having the queries that include the one or more of the identified attributes from a plurality of collections.

9. A computer-implemented method as described in claim 1, further comprising reevaluating membership of each of the clients using the one or more queries that include the one or more identified attributes from the respective said collections such that at least one said client that does not have the identified change is evaluated less frequently that another said client that does have the identified change.

10. A computer-implemented method as described in claim 9, wherein:
the evaluating is performed in real time; and
the reevaluating is performed according to a schedule.

11. One or more computer-readable media comprising computer-executable instructions that are executable to identify which collections of clients in an enterprise system include attributes that are changed and evaluate membership of clients in the identified collections.

12. One or more computer-readable media as described in claim 11, wherein the identification and the evaluation are performed in real time.

13. One or more computer-readable media as described in claim 11, wherein the collections are identified through use of one or more tables, each having one or more references to the attributes and a corresponding flag that is changed when a respective said attribute of a respective said client is changed.

14. One or more computer-readable media as described in claim 11, wherein membership of the client in the identified collections is performable through use of a structured query language (SQL) statement having one or more of the attributes.

15. One or more computer-readable media as described in claim 11, wherein the evaluation is performable such that at least one said collection that does not include one of the changed attributes is not evaluated.

16. One or more computer-readable media comprising computer-executable instructions that are executable to identify which attributes are used to define collections of clients to mange the clients in an enterprise system and monitor those attributes.

17. One or more computer-readable media as described in claim 16, wherein the management includes deploying software.

18. One or more computer-readable media as described in claim 16, wherein at least one of the collections includes one of the attributes that is not included in another one of the collections.

19. One or more computer-readable media as described in claim 16, wherein the monitoring is performable by querying which flags in one or more resource tables that have been changed to indicate that a respective said attribute in the one or more resource tables has been changed.

20. One or more computer-readable media as described in claim 16, wherein the attributes are monitored in real time.
